(19) United States
(12) Patent Application Publication
(10) Pub. No.: US 2021/0345278 A1
(43) Pub. Date: Nov. 4, 2021

(54) TERMINAL AND COMMUNICATION METHOD

(71) Applicant: NTT DOCOMO, INC., Tokyo (JP)

(72) Inventors: Kazuki Takeda, Tokyo (JP); Satoshi Nagata, Tokyo (JP); Tooru Uchino, Tokyo (JP); Hideaki Takahashi, Tokyo (JP); Lihui Wang, Beijing (CN); Shaozhen Guo, Beijing (CN); Xiaolin Hou, Beijing (CN)

(73) Assignee: NTT DOCOMO, INC., Tokyo (JP)

(21) Appl. No.: 17/285,366

(22) PCT Filed: Oct. 16, 2018
(86) PCT No.: PCT/JP2018/038559

§ 371 Date: Apr. 14, 2021

(51) Int. Cl. H04W 56/00

(52) U.S. Cl. CPC H04W 56/0045

(57) ABSTRACT

Provided is a terminal that includes a reception section which receives adjustment information for adjusting a communication timing that is based on a reference point in time, and a control section which determines a specific timing for receiving the adjustment information.

### TECHNICAL FIELD

The present disclosure relates to a terminal and a communication method.

### BACKGROUND ART

In the Universal Mobile Telecommunication System (UMTS) network, Long Term Evolution (LTE) is specified for the purpose of higher speed data rate and low latency, and the like. Furthermore, a system that is a successor to LTE has also been under study for the purpose of broader bandwidth and higher speed than in LTE. Examples of the system that is a successor to LTE include LTE-Advanced (LTE-A), Future Radio Access (FRA), 5th generation mobile communication system (5G), 5G plus (5G+), Radio Access Technology (New-RAT), New Radio (NR), and the like.

It has been considered that, in a radio communication system such a 5G, for example, the considerably high precision of synchronization (for example, also referred to as synchronicity, time synchronization, clock synchronization) on the order of 1 μs is supported between apparatuses (for example, refer to NPL 1).

### CITATION LIST

### Non-Patent Literature

NPL 1
3GPP TR 22.804 v16.1.0, “Study on Communication for Automation in Vertical Domains (Release 16),” September 2018

### SUMMARY OF INVENTION

### Technical Problem

However, a method of easily ensuring the synchronization between apparatuses has not been sufficiently considered.

An object of the present disclosure is to easily ensure synchronization between apparatuses.

### Solution to Problem

A terminal according to one aspect of the present disclosure includes: a reception section that receives adjustment information for adjusting a communication timing that is based on a reference point in time; and a control section that determines a specific timing for receiving the adjustment information.

### Advantageous Effects of Invention

According to the present disclosure, synchronization between apparatuses are easily ensured.

### BRIEF DESCRIPTION OF DRAWINGS

FIG. 1 is a diagram illustrating an example of a configuration of a radio communication system according to an embodiment;

FIG. 2 is a diagram illustrating an example of adjustment processing for synchronization;

FIG. 3 is a diagram illustrating an example of the adjustment processing for the synchronization;

FIG. 4 is a block diagram illustrating an example of a configuration of a base station according to an embodiment;

FIG. 5 is a block diagram illustrating an example of a configuration of a terminal according to an embodiment; and

FIG. 6 is a diagram illustrating an example of hardware configurations of the base station and the terminal according to an embodiment.

### DESCRIPTION OF EMBODIMENTS

An embodiment according to an aspect of the present disclosure below will be described below with reference to the drawings.

Application of 5G system in various use cases has been considered. Example of the user case include an industrial system (which, for example, in some cases, is also referred to as time sensitive networking (TSN)) that includes a motion controller, a sensor, or an actuator, a live performance, a smart grid, a local conference system, and the like. In these cases, in some occasions, a stricter requirement relating to the precision of synchronization between apparatuses (each of which, for example, in some occasion, is also referred to as User Equipment (UE), a terminal, a node, and an entity) is recommended than in an existing system.

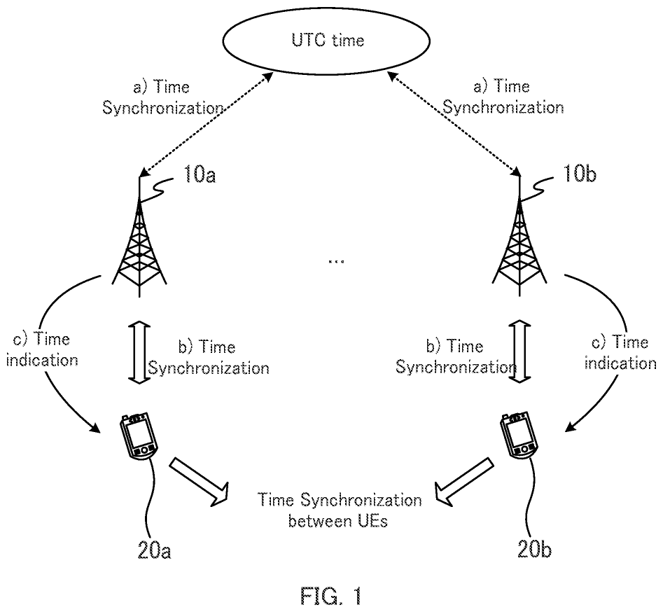

FIG. 1 is a diagram illustrating an example of a configuration of a radio communication system according to an aspect of the present disclosure.

As illustrated in FIG. 1, the radio communication system has base stations (each of which, for example, is referred to as a gNB or an eNB) 10a and 10b and terminals (each of which, for example, is also referred to as UE) 20a and 20b. Terminal 20a, for example, makes a radio connection (radio access) to base station 10a. Terminal 20b, for example, makes a radio connection (radio access) to base station 10b.

It is noted that each of the number of base stations and the number of terminals is not limited to 2 and may be 1 or be 3 or greater. Furthermore, each of the configuration of base station 10 and terminal 20, which will be described below, represents an example of a function according to the present embodiment. Base station 10 and terminal 20 may have a function that is not illustrated. Furthermore, in the case of a function that performs an operation according to the present embodiment, function categorization and a name of a function section is not limited.

As illustrated in FIG. 1, examples of an operation of establishing synchronization between terminal 20a and terminal 20b include an operation a, an operation b, and an operation c that follow.

(Operation a)

Base station 10a and base station 10b acquires time information indicating a reference point in time, for example, from a server (not illustrated), and performs synchronization to the reference point in time. It is noted that FIG. 1 illustrates a case where Coordinated Universal Time (UTC) is used as an example of the reference point in time. However, the reference point in time is not limited to UTC, and, for example, may be a Global Positioning System (GPS) timer, and may be local time. It is noted that, in some cases, UTC may be regarded as being the same as Greenwich Mean Time (GMT).

(Operation b)

Base station 10a and terminal 20a, for example, are synchronized to each other based on the reference in time to which base station 10a is synchronized. In the same manner, base station 10b and terminal 20b are synchronized to each other based on the reference point in time to which base station 10b is synchronized.

(Operation c)

There is a likelihood that a propagation path between base station 10a and terminal 20a and a propagation path between base station 10b and terminal 20b will be different from each other. A difference occurs between the propagation paths between each of the terminals and the base station. Thus, for example, there is a likelihood that a difference will occur in a reception timing (in other words, a propagation delay) of reference point-in-time information in each terminal and that the precision of synchronization between the terminals will decrease. Accordingly, for example, terminal 20a and terminal 20b perform synchronization adjustment (correction) using adjustment information (for example, Timing Advance (TA) that will be described below) relating to a point in time that is notified (for example, indicated) by each of base station 10a and base station 10b.

With the operation described above, each of terminal 20a and terminal 20b is synchronized to the reference point in time (for example, UTC). Each of terminal 20a and terminal 20b is synchronized to the reference point in time, and thus synchronization between terminal 20a and terminal 20b is established.

Next, a method (for example, the operation (c) that is illustrated in FIG. 1) of adjusting the synchronization between the apparatuses will be described below.

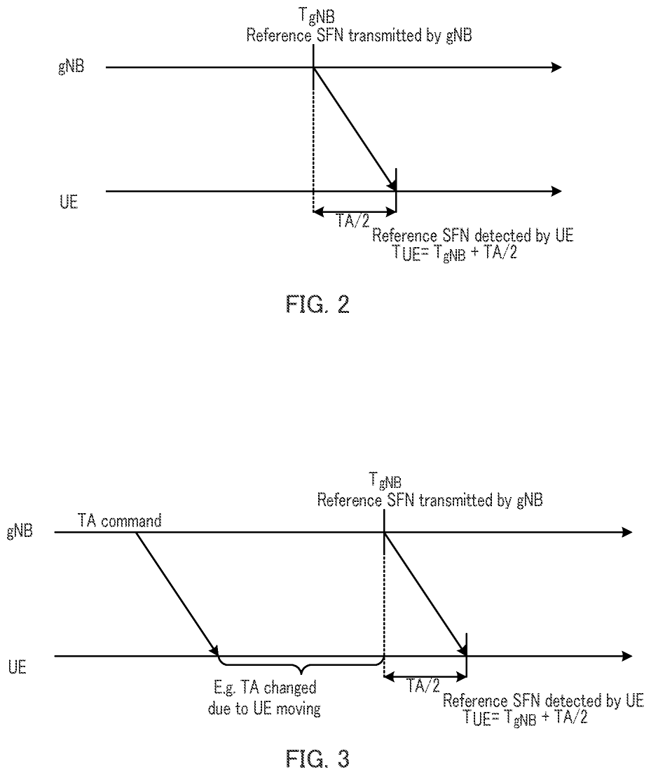

FIG. 2 illustrates an example of adjustment process of the synchronization between the gNB (for example, base station 10a or base station 10b in FIG. 1) and the UE (for example, terminal 20a or terminal 20b).

As illustrated in FIG. 2, the gNB, for example, notifies the UE of information relating to the reference point in time (hereinafter is referred to as time reference information) (for example, this notification corresponds to the operation (b) in FIG. 1).

For example, a reference point in time (hereinafter expressed “T_{gNB}”) that is acquired by the gNB is included in the time reference information. Furthermore, furthermore, information (which, for example, is referred to as a reference System Frame Number (SFN)) indicating at which frame timing (for example, a reference SFN) the synchronization to the reference point in time T_{gNB} takes place may be included in the time reference information. For example, the point in time “T_{gNB}” may indicate a point in time at an ending boundary of a frame that is indicated by the reference SFN. It is noted that any other information which is different from T_{gNB} and the reference SFN may be included in the time reference information.

Furthermore, the time reference information, for example, is notified by the gNB to the UE. For the notification to the UE by the gNB, for example, system information (for example, a System Information Block (SIB)) that is an example of report information, or higher layer signaling (also referred to as a higher layer parameter or Radio Resource Control (RRC) signaling) are used. The system information that is used for the notification of the time reference information, for example, is SIB 9 in a 5G (NR) system or SIB 16 in an LTE system. Furthermore, for the notification of the time reference information, for example, UE-dedicated RRC signaling (for example, dedicated RRC signaling or unicast RRC signaling) may be used.

Furthermore, as illustrated in FIG. 2, the gNB notifies (in other words, transmits or delivers) the UE of the adjustment information (for example, a TA command (TAC)) indicating an adjustment value for adjusting communication timing that is based on the reference point in time. The TA command, for example, is an adjustment value for the gNB to synchronize and receive signals that are transmitted from multiple pieces of UE, which are different in a propagation path or a distance from each other, to the gNB. For example, a value that is two times the time that corresponds to the propagation path, which is taken for a signal to reach the UE from the gNB, is configured for accumulation value of the TA command. In other words, a value that is half the accumulation value of the TA command indicates the propagation delay time that is added in a manner that corresponds to the propagation path between the gNB and the UE.

It is noted that the TA command may be information indicating the time, as is, that corresponds to the propagation delay, and may be information (for example, an index or the like) for computing the time that corresponds to the propagation delay.

Furthermore, the TA command, for example, is notified using a Random Access Response (RAR (or message 2)), in Random Access (RA) processing. Furthermore, the TA command is notified, for example using a Media Access Control Control Element (MAC CE), in a case that is different from the RA processing.

For example, the gNB generates the TA command for every UE and transmits each TA command to the corresponding UE. The UE receives the TA command (which, for example, is expressed as “TA”) and then computes a timing adjustment value (for example, TA/2 in FIG. 2) based on the TA command. Using the computed timing adjustment value or a value that results from accumulating the timing adjustment values, the UE can adjust the point in time T_{gNB} that is included in the time reference information and can compute a point in time T_{U}E (=T_{gNB}+TA/2). Furthermore, for example, in the case that is different from the RA processing, each time the TA command is notified, the UE can update the timing adjustment value (more precisely, the accumulation value of the TA command) using a new TA command. With this update, in FIG. 2, the UE, for example, can be synchronized to the reference point in time that is notified by the gNB, according to a change in a UE communication environment.

For example, each of a set of base station 10a and terminal 20a and a set of base station 10b and terminal 20b, which are illustrated in FIG. 1 performs the same synchronization processing as the gNB and the UE that is illustrated in FIG. 2. Accordingly, each of terminal 20a and terminal 20b that are illustrated in FIG. 1 is synchronized to the reference point in time, and as a result, terminal 20a and terminal 20b are in a state of being synchronized to each other.

At this point, in 3rd Generation Partnership Project (3GPP) Release 15, a transmission timing of the TA command (which, in some cases, is also referred to as a transmitting opportunity, a transmitting chance, or a transmitting occasion) is determined by the gNB. For this reason, regardless of the fact that a situation of a propagation path for the UE changed, in some cases, the TA command is not notified by the gNB to the UE. In this case, because the UE performs the adjustment processing using the past TA command, there is a likelihood that the precision of synchronization will decrease.

For example, as illustrated in FIG. 3, the UE performs the adjustment processing using the time reference information and the TA command that are notified by the gNB. However, as illustrated in FIG. 3, for example, in a case where the UE moves during a duration from when the TA command is received to when the time reference information is received, there is a likelihood that the situation of the propagation path (for example, the propagation delay) will change between the gNB and the UE. In other words, there is a likelihood that the TA command received by the UE in the past will not reflect a current situation of the propagation path between the gNB and the UE. Consequently, as illustrated in FIG. 3, although the synchronization processing is controlled using the TA command that is received in the past by the UE, the precision of synchronization in the UE decreases, and a requirement for the precision of synchronization between pieces of UE are not satisfied. For example, in a use case where the requirement for the precision of synchronization, which is described above, is stricter than in the existing system, there is a high likelihood that the requirement for the precision of synchronization between the pieces of UE will not be satisfied.

Accordingly, in the present disclosure, a synchronization method of being capable of improving the precision of synchronization between the pieces of UE is described.

[Configuration of the Base Station and the Terminal]

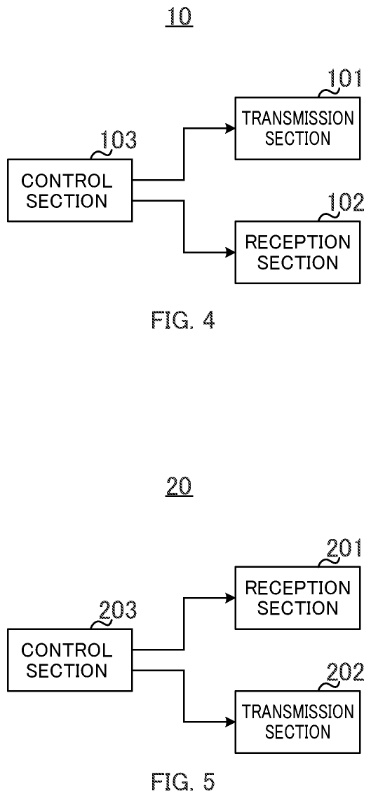

FIG. 4 is a block diagram illustrating an example of a configuration of base station 10 (for example, base station 10a or base station 10b that is illustrated in FIG. 1) according to the present embodiment. The base station 10, for example, includes transmission section 101, reception section 102, and control unit 103.

Transmission section 101 transmits a signal (a downlink signal) destined for terminal 20 to terminal 20. For example, under the control of control section 103, transmission section 101 transmits the downlink signal.

The downlink signal, for example, may include the system information (for example, SIB 9) including the time reference information, the higher layer signaling including the time reference information, a RA message (for example, the RAR) including the TA command, or the MAC CE including the TA command.

Reception section 102 receives a signal (an uplink signal) that is transmitted from terminal 20. For example, under the control of control section 103, reception section 102 receives the uplink signal. The uplink signal, for example, includes a RA preamble, a Measurement Report (MR) indicating a result of measurement of communication quality in terminal 20, channel quality indicator, a control channel signal, a data channel signal, a reference signal, or the like. It is noted that the channel quality indicator, for example, is channel quality information (CQI). The control channel, for example, is a Physical Uplink Control Channel (PUCCH), and the data channel, for example, is a Physical Uplink Shared Channel (PUSCH). Furthermore, the reference signal, for example, is a Sounding Reference Signal (SRS).

Control unit 103 performs control of transmission processing in transmission section 101 and reception processing in reception section 102. For example, control unit 103 controls the transmission processing (for example, the transmission timing of the TA command) of the TA command in transmission section 101.

FIG. 5 is a block diagram illustrating an example of a configuration of terminal 20 (for example, terminal 20a or terminal 20b that is illustrated in FIG. 1) according to the present embodiment. Terminal 20, for example, includes reception section 201, transmission section 202, and control section 203.

Reception section 201 receives the downlink signal that is transmitted from base station 10. For example, under the control of the control section 203, reception section 201 receives the downlink signal. It is noted that, for example, reception section 201 may directly receive a signal that is transmitted from any other terminal 20 (not illustrated), without base station 10 being involved.

Transmission section 202 transmits the uplink signal to base station 10. For example, under the control of control session 203, transmission section 202 transmits the uplink signal. It is noted that transmission section 202, for example, may directly transmit a signal destined for any other terminal 20 (not illustrated) without base station 10 being involved.

Control section 203 performs control of the reception processing in reception section 201 and of the transmission processing in transmission section 202. For example, control section 203 detects the TA command from the received downlink signal. In doing so, control section 203, for example, assumes (or specifies) that the TA command is transmitted at a specific timing, and thus controls reception of the TA command. Then, control section 203 causes the communication timing to be the reference point in time using the detected TA command.

[Method of Notifying the TA Command]

Next, an example of a method for base station 10 to notify terminal 20 of the TA command will be described.

<Notification Method 1>

In notification method 1, the transmission timing of the TA command is determined with a prescribed periodicity.

Terminal 20, for example, determines a specific timing for receiving the TA command based on the prescribed periodicity that is configured for terminal 20.

For example, with the higher layer signaling such as the RRC signaling, a transmission periodicity of the TA command (or a transmission gap) is configured for terminal 20. A value of the transmission periodicity may be configured in the form of P1 [ms] and may be configured in the form of P2 [slot]. Furthermore, for example, with the higher layer signaling such as the RRC signaling, an offset for determining the transmission timing (for example, a starting timing or the like) of the TA command that is transmitted periodically may be configured for terminal 20. A value of the offset may be configured to be added in the form of O1 [ms] to the front or rear of the SFN and may be configured to be in the form of O2 [slot].

Alternatively, a timer indicating a timing at which the TA command is expected to be transmitted may be configured for terminal 20. With the higher layer signaling such as the RRC signaling, a time length of the timer may be in the form of T1 [ms] or T2 [slot]. In a case where the TA command is received, or in a case where a TA timer expires, terminal 20 resets or stops the TA timer. In a case where the TA timer expires in a state where the TA timer is activated, terminal 20 expects the TA command to be notified after the TA timer expires.

For example, the parameter (for example, the periodicity or the offset) is configured based on the time reference information for terminal 20. For example, in a case where variable granularity is configured for the reference point in time (for example, T_{gNB} that is illustrated in FIG. 2) that is included in the time reference information, the stricter the requirement of the precision of synchronization, the more finely the granularity of the reference point in time can be configured. Accordingly, for example, the more finely the granularity of the reference point in time is configured for terminal 20, the shorter the transmission periodicity of the TA command may be configured to be.

Base station 10, for example, configures the periodicity or the offset of the TA command based on the time reference information that corresponds to terminal 20. In the same manner, terminal 20 may configure (or derive) the periodicity or the offset of the TA command based on the time reference information that is notified by base station 10.

Base station 10 repeatedly transmits the TA command according to the transmission periodicity that is configured, using as a reference the transmission timing (for example, the subframe) that is determined by the offset). With this processing, terminal 20 can receive the TA command according to the transmission periodicity in accordance with the precision of synchronization that is required of terminal 20.

Furthermore, for example, each time the time reference information is transmitted (for example, is transmitted periodicity or aperiodically), the transmission periodicity or the offset of the TA command may be updated. With this processing, for example, the periodicity of the TA command is updated according to the reference point in time. It is noted that the TA command, for example, may be notified by base station 10 to terminal 20 at the same timing as the time reference information is notified, or after a prescribed transmission gap.

With notification method 1, the TA command is periodicity notified by base station 10 to terminal 20. Because of this, terminal 20 can be synchronized to base station 10 using the TA command suitable for a current situation of the propagation path for terminal 20. Consequently, the precision of synchronization in terminal 20 can be improved.

Furthermore, with notification method 1, the TA command is transmitted periodically according to the transmission periodicity that is configured. Therefore, with notification method 1, the synchronization to reference point in time can be performed by simple processing without performing complicated processing for determining the transmission timing of the TA command in base station 10 and terminal 20.

It is noted that in notification method 1, the periodicity or the offset of the TA command may be configured based on any other parameter relating to terminal 20, which is different the granularity of the reference point in time.

Furthermore, the periodicity or the offset of the TA command may be a value that is configured in advance and a value that is configured by base station 10, without depending on a parameter relating to terminal 20.

<Notification Method 2>

In notification method 2, the transmission timing of the TA command is determinedness by reception of the configuration information relating to terminal 20.

For example, in a case where prescribed processing for terminal 20 occurs (in other words, an even occurs) in base station 10, the TA command is notified. In other words, the transmission of the TA command is triggered by the occurrence of processing for terminal 20 in base station 10.

Terminal 20, for example, determines a specific timing for receiving the TA command, based on the reception of the configuration information relating to terminal 20.

An example of an event in notification method 2 will be described below.

(Notification Method 2-1)

In notification method 2-1, the transmission timing of the TA command is determined by the reception of the time reference information (for example, information relating to the reference point in time) in terminal 20.

For example, the TA command is notified by base station 10 to terminal 20 after base station 10 transmits the time reference information to terminal 20. In other words, the transmission of the TA command is triggered by the transmission of the system information (for example, SIB 9) or the RRC signaling dedicated to terminal 20.

For example, the transmission gap (time gap) between the time reference information and the TA command may be a prescribed value and may be configured with the higher layer signaling such as the RRC signaling. The transmission gap between the time reference information and the TA command, for example, may be a prescribed value that is 0 (that, in other words, corresponds to the same transmission timing) or is greater than 0. For example, the transmission gap may be configured according to processing capability of terminal 20 (UE processing capability) (for example, the capability relating to whether or not multiple signals are capable of being received at the same time).

Base station 10, for example, transmits the TA command in a prescribed transmission gap after the time reference information is transmitted to terminal 20. Terminal 20 assumes that the TA command is transmitted in the transmission gap that is configured, after the reception of the time reference information is detected.

With notification method 2-1, terminal 20, for example, configures a difference between a reception timing of the time reference information and a reception timing of the TA command to be at or below a threshold, and thus adjust the reference point in time using the TA command that reflects a situation of a propagation path between base station 10 and terminal 20. Consequently, the precision of synchronization in terminal 20 can be improved.

(Notification Method 2-2)

In notification method 2-2, in a case where the parameter that is configured for terminal 20 is changed (for example, reconfigured), the TA command is notified by base station 10 to terminal 20. In other words, the transmission of the TA command is triggered by performing configuration on terminal 20.

As one example, in a case where a frequency band (for example, a Component Carrier (CC)) that is configured for terminal 20 is changed (for example, added, deleted, activated, or deactivated), base station 10 notifies terminal 20 of the TA command. In a case where the configuration information indicating the configuration (or changing) of the frequency band for terminal 20 is detected (or received), terminal 20 assumes that the TA command is transmitted at a specific timing.

For example, the propagation delay between base station 10 and terminal 20 can vary depending on a frequency or coverage of each CC. In a case where the CC that is configured for terminal 20 is changed, base station 10 configures the TA command in accordance with a configuration (or a setting) of a post-change CC. With this processing, terminal 20 can be synchronized to base station 10 using the TA command suitable for the configuration of the post-change CC.

As another example, in a case where a Transmission and Reception Point (TRP) that is configured for terminal 20 is changed (for example, added, deleted, activated, or deactivated), base station 10 notifies terminal 20 of the TA command. In a case where the configuration information indicating the configuration (or changing of the configuration) of the TRP is detected (or received), terminal 20 assumes that the TA command is transmitted at a specific timing.

For example, the propagation delay between each TRP and terminal 20 can vary. In a case where the TRP is changed that is configured for terminal 20, base station 10 configures the TA command in accordance with the configuration (or the configuration) of the post-change TRP. With this processing, terminal 20 can be synchronized to base station 10 using the TA command suitable for the configuration of the post-change TRP.

With notification method 2-2, for example, in a case where the situation of the propagation path is changed by the configuration (or the changing of the configuration) for terminal 20, terminal 20 can be synchronized with base station 10 using the TA command that reflects a post-change situation of the propagation path. Consequently, the precision of synchronization in terminal 20 can be improved.

It is noted that the transmission timing of the TA command may be determined based on both of the configuration of the CC and the configuration of the TRP. Furthermore, the configuration for terminal 20 is not limited to the configuration of the CC and the configuration of the TRP. The configuration for terminal 20 may be a configuration in which the situation of the propagation path in terminal 20 can be changed.

Notification method 2-1 and notification method 2-2 are described above. It is noted that notification method 2-1 and notification method 2-2 may be combined.

With notification method 2 that includes notification method 2-1 and notification method 2-2, the TA command is notified to terminal 20 according to processing (for example, transmission processing of the time reference information, or the changing (or reconfiguration) of the configuration) for terminal 20 in base station 10. Terminal 20 can be synchronized to base station 10 using the TA command suitable for the situation of the propagates path that changes with the occurrence of a prescribed event. Consequently, the precision of synchronization in terminal 20 can be improved.

<Notification Method 3>

In notification method 3, the transmission timing of the TA command is determined by a change in a communication state of terminal 20.

Terminal 20, for example, determines a specific timing for receiving the TA command based on the change in the communication state of terminal 20.

For example, in a case where the change in the communication state in terminal 20 satisfies a prescribed condition, terminal 20 transmits a request signal for making a request for the transmission of the TA command, to base station 10. In other words, the transmission of the TA command is triggered by the transmission request made by terminal 20.

For example, terminal 20 determines whether or not to make a request for transmission of a new TA command, based on a state of terminal 20. In a case where the transmission of the new TA command is requested, terminal 20 transmits the request signal for making a request for the transmission of the TA command, to base station 10.

The request signal, for example, may be transmitted using the MACCE, the PUCCH (for example, the Scheduling Request (SR)) or the PUSCH. Furthermore, in a case where the request signal is transmitted using the PUSCH, for example, the PUSCH (grant based transmission) that is allocated by a UL grant, or the PUSCH (configured grant transmission) without the UL grant may be used.

After receiving the request signal for the TA command from terminal 20, for example, base station 10 configures the TA command according to the situation of the propagates path between base station 10 and terminal 20, and transmits the TA command that is configured, to terminal 20.

An example of a method for terminal 20 to make a request to base station 10 for the transmission of the TA command will be described below.

(Request Method 1)

In request method 1, in a case where a request for report information (for example, the system information such as on-demand SI) is made to base station 10, terminal 20 makes a request to base station 10 for the transmission of the TA command.

For example, when a request is made for the system information (for example, SIB 9) that includes the time reference information, terminal 20 transmits not only the request signal for requesting the transmission of the system information, but also the request signal for requesting the transmission of the TA command, to base station 10. The request for the system information may be made by transmitting a Physical Random Access Channel (PRACH) or the Scheduling Request (SR) and may be made by including a prescribe message in the PUSCH. With this processing, terminal 20 can receive the TA command from base station 10 along with the time reference information.

It is noted that the transmission gap (time gap) between the time reference information and the TA command may be at a prescribed value that is 0 or is greater than 0.

(Request Method 2)

In request method 2, in a case where the TA command is not received from base station 10 during a prescribed duration (which, for example, is expressed as “T”), terminal 20 makes a request to base station 10 for the transmission of the TA command.

At this point, as an example, a case is described where the TA command is notified periodically to terminal 20.

In this case, for example, a prescribed time T is expresses as T=P×N where P denotes a transmission periodicity of the TA command and N denotes an upper limit value of the number of time that terminal 20 does not receive the TA command contiguously at a reception timing with every transmission periodicity P of the TA command. It is noted that T=P×N, for example, is configured to a value that is smaller than the expiration time in a Time Alignment timer.

In a case where the TA command is neither delivered, nor received during a prescribed time T, terminal 20 transmits the request signal for making a request for the transmission of the TA command, to base station 10.

During the prescribed time T during which terminal 20 does not receive the TA command, there is a likelihood that the situation of the propagation path will change between base station 10 and terminal 20. In request method 2, terminal 20 can be synchronized to base station 10 using the TA command that is acquired after the prescribed time T elapsed after the point in time at which the TA command was received last time.

It is noted that the case where terminal 20 makes a request to base station 10 for the transmission of the TA command based on the time during which the TA command is not continuously received is described here. Instead of this processing, terminal 20 may make a request to base station 10 for the transmission of the TA command based on the number of times that the TA command is not continuously received.

For example, in a case where the TA command is notified periodically, if the TA command cannot be received at the reception timing of the TA command, terminal 20 increments a counter (adds 1). On the other hand, in a case where the TA command is received, terminal 20 resets (or initializes) the counter. In a case where a value of the counter exceeds a threshold (in other words, the number of times that the TA command is not continuously received, terminal 20 transmits the request signal for making a request for the transmission of the TA command, to base station 10.

With this processing, terminal 20 can be synchronized with base station 10 using the TA command that is received after the prescribed number of times of that the reception timing occurs is exceeded after the TA command was received last time.

Furthermore, the configuration in which the TA command is notified periodicity is described here. However, request method 2 can be applied to a configuration in which the TA command is notified aperiodically. For example, terminal 20 may make a request to base station 10 for the transmission of the TA command after the prescribed time T elapsed from the point in time at which the TA command was received last time.

(Request Method 3)

In request method 3, in a case where an amount of change in a moving speed of terminal 20 exceeds a threshold, terminal 20 makes a request to base station 10 for the transmission of the TA command.

For example, in a case where the amount of the change in the moving speed of terminal 20 exceeds a threshold of X [km/h], terminal 20 transmits the request signal form making a request for the transmission of the TA command, to base station 10. It is noted that the moving speed of terminal 20, for example, is measured by a sensor (not illustrated) that is included in terminal 20.

In a case where the amount of the change in the moving speed of terminal 20 exceeds the threshold of X, there is a likelihood that the situation of the propagation path between base station 10 and terminal 20 will change. In request method 3, terminal 20 can receive the TA command that corresponds to the situation of the propagation path in accordance with a movement of terminal 20, from base station 10. Consequently, the precision of synchronization in terminal 20 can be improved.

It is noted that the threshold of X may be defined in advance and may be configured by base station 10. The threshold of X may be configured according to the requirement of the precision of synchronization for terminal 20. For example, the stricter the requirement of the precision of synchronization, the smaller value the threshold of X may be configured to. With this configuration, the stricter the requirement of the precision of synchronization, the more opportunity of transmitting the TA command can be provided and the more the precision of synchronization can be improved in terminal 20.

(Request Method 4)

In request method 4, in a case where a time difference between paths along which a signal that is transmitted from base station 10 reaches terminal 20 exceeds a threshold, terminal 20 makes a request to base station 10 for the transmission of the TA command.

For example, terminal 20 computes a time difference between a reception path along which the signal reaches terminal 20 fastest and a reception path along which the signal reaches terminal 20 latest, among paths (or referred to reception paths) along which the signal is transmitted from base station 10 to terminal 20. For example, in a case where the computed time difference with the reception path exceeds a threshold of Y, terminal 20 transmits the request signal for making a request for the transmission of the TA command, to base station 10. When receiving the request signal, base station 10 transmits the TA command to terminal 20.

In a case where the time difference with the reception path in terminal 20 exceeds the threshold of Y, the communication quality decreases due to the communication environment (in other words, multi-path environment) of terminal 20). In request method 4, in a case where the time difference with the reception path exceeds the threshold of Y, terminal 20 can receive the TA command that corresponds to a current propagation path for terminal 20 by making a request to base station 10 for the transmission of the TA command. Consequently, the precision of synchronization in terminal 20 can be improved.

It is noted that the reception path that is used by terminal 20 for the computation of the time difference is not limited to the path along which a signal first reaches terminal 20 and the path along which a signal last reaches terminal 20, and, for example, may be paths along signals reach terminal 20 at different timings. For example, the reception path that is used by terminal 20 for the computation of the time difference may be a path along which a signal reaches terminal 20 close to a timing at which a signal first reaches terminal 20 along a path, a path along which a signal reach terminal 20 close to a timing at which a signal last reaches terminal 20 along a path, or the like.

Furthermore, the threshold of Y may be defined in advance and may be configured by base station 10. The threshold of Y may be configured according to the requirement of the precision of synchronization for terminal 20. For example, the stricter the requirement of the precision of synchronization, the smaller value the threshold of Y may be configured to. With this configuration, the stricter the requirement of the precision of synchronization, the more opportunity of transmitting the TA command can be provided and the more the precision of synchronization can be improved in terminal 20.

(Request Method 5)

In request method 5, in a case where a time difference between a path along which the tag command reaches terminal 20 at the time of the reception of the TA command and a path along which the reference signal reaches terminal 20 at the time of the reception of the reference signal exceeds a threshold, terminal 20 makes a request of base station 10 for the transmission of the TA command.

For example, terminal 20 computes the time difference between the reception path along which the TA command reaches terminal 20 at the time of the reception of the TA command that is last transmitted from base station 10 to terminal 20 and the reception path along which the reference signal reaches terminal 20 at the time of the reception of the reference signal that is last transmitted from base station 10 to terminal 20. It is noted that terminal 20 may use, for example, a path (for example, a path along which the TA command or the reference signal fastest reaches terminal 20, a path along which the TA command or the reference signal latest reaches terminal 20, or the like) along which the TA command or the reference signal reaches terminal 20 at a different timing, among the reception paths along which the TA command or the reference signal reach terminal 20 at the time of the reception of the TA command or the reference signal.

In a case where, for example, the computed time difference between the reception paths exceeds a threshold of Z, terminal 20 transmits the request signal for making a request for the transmission of the TA command, to base station 10. When receiving the request signal, base station 10 transmits the TA command to terminal 20. It is noted that the threshold of Z, for example, may be the same value as or a value different from the threshold of Y described above in request method 4.

In a case where the time difference in terminal 20 between the reception path and the reception path at the time of the reception of the TA command exceeds the threshold of Z, there is a likelihood that a communication environment (in other words, a multi-path environment) of terminal 20 will change compared with the point in time at which the TA command is received and thus that the precision of synchronization will decrease. With request method 5, in a case where the time difference between the reception paths exceeds the threshold of Z, terminal 20 makes a request to base station 10 for the transmission of the TA command, and thus can receive the TA command that corresponds to a current situation of the propagation path for terminal 20. Consequently, the precision of synchronization in terminal 20 can be improved.

It is noted that the threshold of Z may be defined in advance and may be configured by base station 10. The threshold of Z may be configured according to the requirement of the precision of synchronization for terminal 20. For example, the stricter the requirement of the precision of synchronization, the smaller value the threshold of Z may be configured to. With this configuration, the stricter the requirement of the precision of synchronization, the more opportunity of transmitting the TA command can be provided and the more the precision of synchronization can be improved in terminal 20.

An example of the method for terminal 20 to make a request for the transmission of the TA command is described above.

With notification 3 that includes request method 1 to request method 5, at a timing at which the situation of the propagation situation for terminal 20 changes, a request is made for the transmission of the TA command from terminal 20 to base station 10. There is a likelihood that terminal 20, rather than base station 10, will detect a change (for example, a change that is deviation from a reception timing) in the situation of the propagation path for terminal 20. Consequently, terminal 20 makes a request for the transmission of the TA command, and thus terminal 20 can earlier acquire the TA command, which corresponds to the change in the situation of the propagation path for terminal 20. With this processing, terminal 20 can be synchronized to base station 10 using the TA command that is configured according to the change in the situation of the propagation path for terminal 20. Consequently, the precision of synchronization in terminal 20 can be improved.

It is noted that at least two methods of request method 1 to request method 5 may be combined.

Methods 1 to 3 of notifying the TA command are described above.

In the present embodiment, terminal 20 determines a specific timing for receiving the TA command and, based on the determination that the TA command is transmitted at the specific timing, controls the reception of the TA command. With this control, terminal 20 can specify “when” and “how” the TA command is transmitted by base station 10. Consequently, according to the present embodiment, the synchronization to the reference point in time is easy to ensure in terminal 20. The ease with which the synchronization to the reference point in time is ensured in each terminal 20, for example, makes it easy to ensure the synchronization between terminals 20 and can improve the precision of synchronization between terminals 20.

Furthermore, according to the present embodiment, terminal 20 may perform the reception processing on the TA command at a timing at which the TA command is transmitted by base station 10. In other words, terminal 20 may not perform the reception processing (in other words, blind detection) of the TA command at a timing that is different from a transmission timing of the TA command. Therefore, the processing in terminal 20 can be simplified.

Furthermore, in the present embodiment, the transmission timing of the TA command is determined by at least one of a prescribed periodicity, the reception of configuration information relating to terminal 20, and the change in the communication state of terminal 20. For example, base station 10 determines the transmission timing of the TA command based on the information relating to terminal 20.

With this processing, the TA command, for example, is notified by base station 10 to terminal 20 based on the situation of the propagation path for terminal 20. Because of this, terminal 20 can control the synchronization to the reference point in time using the TA command suitable for the situation of the propagation path for terminal 20.

For example, in 3GPP Release 15, in some cases, the gNB does not notify the UE of the TA command, regardless of the change in the situation of the propagation path for the UE. In contrast to this, in the present embodiment, there is a high likelihood that the TA command will be notified close to a timing at which the situation of the propagation path for terminal 20 (for example, the UE) changes. In other words, according to the present embodiment, terminal 20 can receive the TA command with higher frequency compared with 3GPP Release 15.

Consequently, according to the present embodiment, the precision of synchronization in terminal 20 can be improved. For example, in the present embodiment, the precision of synchronization between apparatuses (for example, pieces of UE) can be improved.

It is noted that in the embodiment described above, in a case where terminal 20 cannot receive the TA command at the reception timing that is configured, for example, a value (which, m for example, is expressed as NTA) that is retained in terminal 20 may be assumed in the TA command. NTA, for example, may be 0 and may be a value other than 0. Furthermore, NTA, for example, may be a value that is stipulated (or defined) in advance, and may be a value that is configured by base station 10. In this case, even in a case where terminal 20 cannot receive the TA command, terminal 20 can be synchronized to base station 10 using the TA command.

Furthermore, in the embodiment described above, the case is described where the TA command, for example, is periodically transmitted at the timing at which the processing (in other words, an event) for terminal 20 occurs in base station 10 or at the timing at which terminal 20 makes a request to base station 10 for the transmission of the TA command. However, in addition to the transmission timing of the TA command described above, base station 10 may transmit the TA command to terminal 20 based on the determination by base station 10.

For example, based on contents of the uplink signal (for example, the MR, the CQI, or the SRS) that is transmitted from terminal 20, base station 10 may determined whether or not the TA command is transmitted. Furthermore, based on a demodulation timing of the PUSCH or the PUCCH that is transmitted from terminal 20, base station 10 may determine whether or not the TA command is transmitted.

With this processing, in addition to the transmission timing that is determined by the operation according to the resent embodiment, terminal 20 can receive the TA command at a transmission timing that is determined by determination which is based on the uplink signal of terminal 20 in base station 10. Therefore, the precision of synchronization in terminal 20 can be improved.

Furthermore, in the embodiment described above, the user case is described where the synchronization is established in the communication with the UE, which is illustrated in FIG. 1. However, the user case in which the present disclosure finds application is not limited to this. For example, the present disclosure can find application in a user case in which the synchronization can be established in the communication between the gNB and the UE and in which the uplink signal is transmitted.

Furthermore, the TA command is not limited to a case where the TA command is notified using the RAR or the MAC CE. For example, the TA command may be notified using a PDSCH that is different from the system information (for example, SIB 9) which is used for the notification of the time reference information, may be notified using higher layer signaling that is the same as or different from the time reference information, and may be notified using a downlink control channel (for example, Downlink Control Information (DCI) of a Physical Downlink Control Channel (PDCCH).

Furthermore, at least two of notification method 1, notification method 2 (for example, at least one of notification method 2-1 and notification method 2-2), and notification method 3 (for example, at least one of request method 1 to request method 5) may be combined.

(Hardware Configuration)

It is noted that the block diagram that is referred to for the description of the embodiment illustrates blocks on a per-function basis. These functional blocks (constituent sections) are realized by an arbitrary combination of at least pieces of hardware or pieces of software. Furthermore, a method of realizing each functional block is not particularly limited. That is, each functional block may be realized using one apparatus that results from physical or logical coupling, and may be realized by making a connection to two or more apparatuses that are separated physically or logically, in a direct or indirect manner (for example, such as in a wired or wireless manner) and using these multiple apparatuses. The functional block may be realized by combining the one or more apparatuses, which are described above, and a piece of software.

The functions include determining, deciding, judging, calculating, computing, processing, deriving, investigating, looking-up, ascertaining, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like, and are not limited to these. For example, a functional block (a constituent section) that causes a transmission function to be performed is referred to a transmission section (a transmitting unit) or a transmitter. Any one of the functional blocks is as described above, and a method of realizing a function block is not particularly limited.

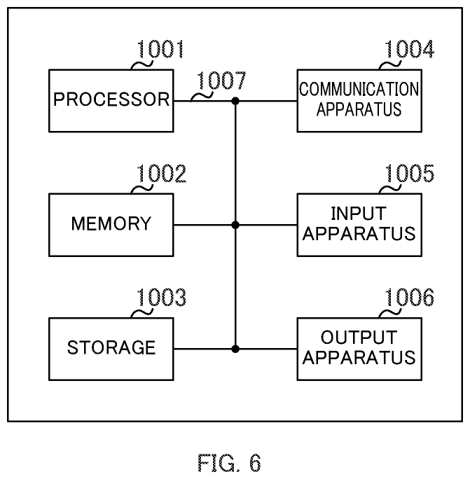

For example, a base station, a terminal, and the like according to an embodiment in the present disclosure may function as a computer that performs processing for a radio communication method in the present disclosure. FIG. 6 is a diagram illustrating an example of a hardware configuration of a base station and a terminal according to an embodiment in the present disclosure. Base station 10 and terminal 20, which are described above, may be physically configured as a computer apparatus that includes processor 1001, memory 1002, storage 1003, communication apparatus 1004, input apparatus 1005, output apparatus 1006, bus 1007, and the like.

It is noted that, in the following description, the term apparatus can be replaced with a circuit, a device, a unit, or the like. Hardware configurations of base station 10 and terminal 20 may be employed in such a manner that one or more apparatuses that are illustrated are included, and may be configured without including one or several of the apparatuses.

A prescribed piece of software (a program) is read to be loaded onto a piece of hardware such as processor 1001, memory 1002, or the like, and thus processor 1001 performs an arithmetic operation, thereby controlling communication by communication apparatus 1004 or controlling at least one of reading and writing of data from and to memory 1002 and storage 1003. When this is done, a function of each of base station 10 and terminal 20 is realized.

Processor 1001, for example, causes an operating system to operate and thus controls an entire computer. Processor 1001 may be configured with a central processing apparatus (a central processing unit (CPU)) that includes an interface with a peripheral apparatus, a control apparatus, an arithmetic operation apparatus, a register, and the like. For example, control section 103 and control section 203, which are described above, and the like may be realized by processor 1001.

Furthermore, processor 1001 reads a program (a program code), a software module, data, and the like from at least one of storage 1003 and communication apparatus 1004 into memory 1002, and performs various processing operations according to these. As the program, a program is used that causes the computer to perform at least one or several of the operations in the embodiment described above. For example, control section 103 of base station 10 or control section 203 of terminal 20 may be realized by a control program that is stored in memory 1002 and operates in processor 1001, and may also be realized in the same manner for any other functional block. The various processing operations described above are described as being performed by two one processor 1001, but may be performed by two or more processors 1001 at the same time or sequentially. Processor 1001 may be integrated into one or more chips. It is noted that the program may be transmitted from a network over an electric telecommunication line.

Memory 1002 is a computer-readable recording medium, and, for example, may be configured with at least one of a Read Only Memory (ROM), an Erasable Programmable ROM (EPROM), an Electrically Erasable Programmable ROM (EEPROM), a Random Access Memory (RAM), and the like. Memory 1002 may be referred to a register, a cache, a main memory (a main storage apparatus), or the like. A program (a program code), a software module, or the like that is executable in order to perform the radio communication method according to the embodiment in the present disclosure can be retained in memory 1002.

Storage 1003 is a computer-readable recording medium, and, for example, may be configured with at least one of an optical disk such as a Compact Disc Rom (CD-ROM), a hard disk drive, a flexible disk, a magneto-optical disk (for example, a compact disk, a digital versatile disk, a Blu-ray (a registered trademark) disk), a smart card, a flash memory (for example, a card, a stick, or a key drive), a floppy (a registered trademark) disk, a magnetic strip, and the like. Storage 1003 may be referred to as an auxiliary storage apparatus. The storage medium described above, for example, may be a database or a server that includes at least one of memory 1002 and storage 1003, or any other suitable medium.

Communication apparatus 1004 is hardware (a transmission and reception device) for performing communication between radio base station or user terminal, and a computer through at least one of a wired network and a wireless network, and, for example, is also referred to as a network device, a network controller, a network card, a communication module, or the like. Communication apparatus 1004, for example, may be configured to include a high frequency switch, a duplexer, a filter, a frequency synthesizer, and the like in order to realize at least one of Frequency Division Duplex (FDD) and Time Division Duplex (TDD). For example, transmission section 101, reception section 102, reception section 201, and transmission section 202, which are described, and the like may be realized by communication apparatus 1004.

Input apparatus 1005 is an input apparatus (for example, a keyboard, a mouse, a microphone, a switch, a button, a sensor, or the like) that receives input from the outside. Output apparatus 1006 is an output apparatus (for example, a display, a speaker, an LED lamp, or the like) that performs output to the outside. It is noted that input apparatus 1005 and output apparatus 1006 may be configured to be integrated into one piece (for example, a touch panel).

Furthermore, apparatuses, such as processor 1001, memory 1002, are connected to bus 1007 for communicating information. Bus 1007 may be configured using a single bus and may be configured using a bus that differs from one apparatus to another.

Furthermore, each of base station 10 and terminal 20 may be configured to include pieces of hardware, such as a microprocessor, a Digital Signal Processor (DSP), an Application Specific Integrated Circuit (ASIC), a Programmable Logic Device (PLD), and a Field Programmable Gate Array (FPGA). One or several of, or all of functional blocks of each of radio base station 10 and user terminal 20 may be realized using the hardware. For example, processor 1001 may be integrated into at least one of these pieces of hardware.

(Information Notification and Signaling)

Information notification is not limited to the aspect and the embodiment, which are described in the present disclosure, and may be performed using any other method. For example, the information notification may be performed with Physical Layer Signaling (for example, Downlink Control Information (DCI), Uplink Control Information (UCI)), Higher Layer Signaling (for example, Radio Resource Control (RRC) Signaling, Medium Access Control (MAC) Signaling, report information (a Master Information Block (MIB)), a System Information Block (SIB)), any other signal, or a combination of these. Furthermore, the RRC signaling may be referred to as an RRC message, and, for example, may be an RRC Connection Setup Message, an RRC Connection Reconfiguration Message, or the like.

(Application System)

Each of the aspects and embodiments, which are described in the present disclosure, may find application in at least one of Long Term Evolution (LTE), LTE-Advanced (LTE-A), SUPER 3G, IMT-Advanced, a 4th generation mobile communication system (4G), a 5th generation mobile communication system (5G), Future Radio Access (FRA), New Radio (NR), W-CDMA (a registered trademark), GSM (a registered trademark), CDMA 2000, Ultra Mobile Broadband (UMB), IEEE 802.11 (Wi-Fi (a registered trademark)), IEEE 802.16 (WiMAX (a registered trademark)), IEEE 802.20, Ultra-WideBand (UWB), Bluetooth (a registered trademark), any other system that uses a suitable system, and a next-generation system that results from the expansion which is based on these. Furthermore, application in a combination of multiple systems (for example, a combination of at least one of LTE and LTE-A and 5G, or the like) may be possible.

(Processing Procedure and Others)

In a processing procedure, a sequence, a flowchart, and the like according to each of the aspects and the embodiment, which are described in the present disclosure, the order may be changed as long as there is no conflict. For example, various step elements of the method that is described in the present disclosure are presented in the exemplary order and is not limited to the presented specific order.

(Operation by the Base Station)

In some cases, a specific operation as performed by the base station in the present disclosure is performed by a higher node (an upper node) that is at a higher level than the base station, depending on the situation. It is apparent that, in a network that is made up of one or more network nodes each of which has a base station, various operations that are performed for communication with a terminal can be performed two by at least one of the base station and a network node (for example, an MME, an S-GW, or the like is considered, but no limitation to these is imposed) other than the base station. In the above description, the case where one network node other than the base station is provided is given as an example, but a combination of other multiple network nodes (for example, an MME and an S-GW) may be provided.

(Input And Output Direction)

Information (refer to the subtitle “Information And Signal”) or the like can be output from a higher layer (or a lower layer) to the lower layer (or the higher layer). The information or the like may be input and output through multiple network nodes.

(Handing the Information And the like that Are Input And Output)

The information and the like that are input and output may be retained in a specific place (for example, a memory) and may be managed using a management table. The information and the like that are input and output can be overwritten, updated, or added. The information and the like that are output may be deleted. The information and the like that are input may be transmitted to any other apparatus.

(Judging Method)

Judging may be performed with a value (0 or 1) that is represented by one bit, may be performed with a boolean value (true or false), and may be performed with comparison of numerical values (for example, comparison with a prescribed value).

(Software)

Software is referred to as software, firmware, middleware, a microcode, or hardware description language, but, regardless of whether or not any other terms are available, can be broadly interpreted to mean a command, an instruction set, a code, a code segment, a program code, a program, a subprogram, a software module, an application, a software application, a software package, a routine, a subroutine, an object, an executable file, an execution file, a procedure, a function, or the like.

Furthermore, the software, the command, the information, and the like may be transmitted and received through a transfer medium. For example, in a case where the software is transmitted from a website, a server, or any other remote source using at least one of a cable technology (a coaxial cable, optical fiber, a twisted pair, a Digital Subscriber Line (DSL), or the like) and a radio technology, at least one of the cable technology and the radio technology (an infrared ray, a microwave, or the like) falls with the definition of the transfer medium.

(Information and Signal)

The information and the signal, which are described in the present disclosure, and the like may be represented using any one of various different technologies. For example, data that can be referred to throughout the above description, an instruction, a command, information, a signal, a bit, a symbol, a chip, and the like may be represented by voltage, current, an electromagnetic wave, a magnetic field or a magnetic particle, a photo field or a photo, or an arbitrary combination of these.

It is noted that the terms which are described in the present disclosure and the terms which are necessary for an understanding of the present disclosure may be replaced with the terms that have the same or similar meaning. For example, at least one of a channel and a symbol may be a signal (signaling). Furthermore, the signal may be a message. Furthermore, a Component Carrier (CC) may be referred to as a carrier frequency, a cell, a frequency carrier, or the like.

(“System” and “Network”)

The terms “system” and “network” that are used in the present disclosure are interchangeably used.

(Names of a Parameter And a Channel)

Furthermore, the information and the parameter, which are described in the present disclosure, and the like may be represented by an absolute value, may be represented using a relative value from a prescribed value, and may be represented using separate corresponding information. For example, a radio resource may be indicated by an index.

A name that is used for the parameter described above is also not a limited name in any respect. Moreover, in some cases, an equation or the like that use these parameters are different from those that are explicitly disclosed in the present disclosure. Various channels (for example, a PUCCH, a PDCCH, and the like) and information elements can be identified with all suitable names. Because of this, various names that are allocated to these various channels and information elements are not limited names in any respect.

(Base Station (Radio Base Station)) In the present disclosure, the terms “base station (BS)”, radio base station”, “fixed station”, “NodeB”, “eNodeb (eNB)”, “gNodeB (gNB)”, “access point”, “transmission point”, “reception point”, “transmission/reception point”, “cell”, “sector”, “cell group”, “carrier”, and “component carrier”, and the like can be interchangeably used. In some cases, the terms “macrocell”, “small cell”, and “femtocell” are used to refer to the base station.

The base station can accommodate one or more (for example, three) cells. In a case where the base station accommodates multiple cells, an entire coverage area that is covered by the base station can be divided into multiple smaller areas. In each of the smaller cells, a communication service can be provided by a base station subsystem (for example, indoors small-sized base station (Remote Radio Head (RRH))). The term “cell” or “sector” refers to one or several portions or all portions of a coverage area that is covered by at least one of a base station and a base station subsystem that perform the communication service in this coverage.

(Terminal)

In the present disclosure, the terms “mobile station (MS)”, “user terminal”, “user equipment (UE)”, and “terminal”, and the like can be interchangeably used.

In some cases, a person of ordinary skill in the art refers to the mobile station as a subscriber station, a mobile unit, a subscriber unit, a radio unit, a remote unit, a mobile device, a wireless device, a wireless communication device, a remote device, a mobile subscriber station, an access terminal, a mobile terminal, a wireless terminal, a remote terminal, a handset, a user agent, a mobile client, or a client, or using several other suitable terms.

(Base Station And Mobile Station)

At least one of the base station and the mobile station may be referred to as a transmission apparatus, a reception apparatus, a communication apparatus, or the like. It is noted that at least one of the base station and the mobile station may be a device that is mounted into a mobile body or the mobile body itself. The mobile body may be a vehicle (for example, an automobile or an airplane), may be an unmanned mobile body (for example, a drone, an autonomous vehicle, or the like), and may be a robot (a manned-type or unmanned-type robot). It is noted that at least one of the base station and the mobile station also includes an apparatus that does not necessarily move at the time of communication operation. For example, at least one of the base station and the mobile station may be Internet-of-Things (IoT) equipment such as a sensor.

Furthermore, the base station in the present disclosure may be replaced with the user terminal. For example, each of the aspects and the embodiment in the present disclosure may find application in a configuration that results from replaying communication between the base station and the user terminal with communication (which, for example, may be referred to as device-to-device (D2D), vehicle-to-everything (V2X), or the like) between each of the multiple user terminals. In this case, terminal 20 may be configured to have the function that base station 10 described above has. Furthermore, the terms “uplink” and “downlink” may be replaced with the expression (for example, “side”) that corresponds to inter-terminal communication. For example, an uplink channel, a downlink channel, and the like may be replaced with a side channel.

In the same manner, the terminal in the present disclosure may be replaced with the base station. In this case, base station 10 is configured to have the function that user terminal 20 described above has.

(Meaning And Interpretation of a Term)

In some cases, the meaning of the terms “determining” and “determining” are broadened to include various operations. Regarding “determining” and “deciding”, for example, a thing that is judged, calculated, computed, processed, derived, investigated, looked up (search or inquiry) (for example, as looked up in a table, a database, or a separate data structure), and ascertained can be inclusively considered as a thing that is determined or decided. Furthermore, regarding to “determining” and “deciding”, a thing that is received (for example, as information is received), transmitted (for example, as information is transmitted), input, output, or accessed (for example, as data in a memory is accessed) can be inclusively considered as a thing that is determined or “decided”. Furthermore, regarding to “determining” and “deciding”, a thing that is resolved, selected, chosen, established, compared, or so on can be inclusively considered as a thing that is “determined” or “decided”. More precisely, regarding to “determining” and “deciding”, a thing on which any operation is performed can be inclusively considered as a thing that is “determined” or “decided”. Furthermore, “determining (deciding)” may be replaced with “assuming”, “expecting”, “considering”, or the like.

The expressions “connected” and “coupled” or all variants of the expressions can mean all direct or indirect connection and coupling between two or more elements, and can imply the presence of one or more intermediate elements between two elements that are “connected” or “coupled” to each other. The connection and the coupling between elements may be made physically, may be made logically, or may be made both physically and logically. For example, “connection” may be replaced with “access”. In the case of the use in the present disclosure, it is considered that two elements are “connected” or “coupled” to each other using at least one of one or more electric wires, a cable, and a printed electric connection, and an electromagnetic energy or the like that has a wavelength in a radio frequency domain, a microwave region, and a light (both visible light and invisible light) region, as several non-limiting and non-inclusive examples.

A reference signal can also be referred to as a Reference Signal (RS), and, according to standards that are applied, may be referred to a pilot.

Unless otherwise specified, the expression “based on” that is used in the present disclosure does not mean “based only on”. In other words, the description “based on” means both “based only on” and based at least on”.

“Section” in a configuration of each of the apparatuses described above may be replaced with “means”, “circuit”, “device”, or the like.

In the present disclosure, in a case where “include”, “including”, and variants of these are used, these terms are intended to have a broad meaning in the same manner as the term “comprising”. Moreover, the term “or” that is used in the present disclosure is intended not to be exclusive OR.

The radio frame may be configured with one or more frames in a time domain. Each of the one or more frames in the time domain may be referred to as a subframe. The subframe may be configured with one or more slots in the time domain. The subframe may be a fixed time length (for example, 1 ms) that does not depend on numerology.

The numerology may be a communication parameter that is applied to at least one of transmission and reception of a certain signal or channel. The numerology, for example, indicates at least one of Subcarrier Spacing (SCS), a bandwidth, a symbol length, a cyclic prefix length, Transmission Time Interval (TTI), the number of symbols per TTI, a radio frame configuration, specific filtering processing that is performed by a transmission and reception apparatus in a frequency domain, specific windowing processing that is performed by the transmission and reception apparatus in the time domain, and the like.

The slot is configured with one or more symbols (an Orthogonal Frequency Division Multiplexing (OFDM) symbol, a Single Carrier Frequency Division Multiple Access (SC-FDMA) symbol, or the like) in the time domain. The slot may be a time unit that is based on the numerology.

The slot may include multiple mini-slots. Each of the mini-slots may be configured with one or more symbols in the time domain. Furthermore, the mini-slot may be referred to as a subslot. The mini-slot may be configured with a smaller number of symbols than the slot. A PDSCH (or a PUSCH) that is transmitted in the time unit that is greater than the mini-slot may be referred to as a PDSCH (or a PUSCH) mapping type A. The PDSCH (or the PUSCH) that is transmitted using the mini-slot may be referred to as a PDSCH (or a PUSCH) mapping type B.

Any one of the radio frame, the subframe, the slot, the mini-slot, and the symbol represents the time unit when transferring a signal. A separate name that corresponds to each of the radio frame, the subframe, the slot, the mini-slot, and the symbol may be used.

For example, one subframe may be referred to as a Transmission Time Interval (TTI), multiple contiguous subframes may be referred to as a TTI, and one slot or one mini-slot may be referred to as a TTI. More precisely, at least one of the subframe and the TTI may be a subframe (1 ms) in the existing LTE, may be a duration (for example, 1 to 13 symbols) that is shorter 1 ms, and may be a duration that is longer than 1 ms. It is noted that a unit that represents the TTI may be referred to a slot, a mini-slot, or the like instead of a subframe.

At this point, the TTI, for example, refers to a minimum time unit for scheduling in radio communication. For example, in an LTE system, the base station performs scheduling for allocating a radio resource (a frequency bandwidth, a transmit power, or the like that is used in each user terminal) in a TTI unit to each user terminal. It is noted that the definition of the TTI is not limited to this.

The TTI may be a transmission time unit, such as a data packet (a transport block) that is channel-coded, a code block, or a codeword, and may be a processing unit, such as scheduling or a link adaptation. It is noted that, when the TTI is assigned, a time section (for example, the number of symbols) to which the transport block, the code block, the codeword, or the like is actually mapped may be shorter than the TTI.

It is noted that, in a case where one slot or one mini-slot is referred to as the TTI, one or more TTIs (that is, one or more slots, or one or more mini-slots) may be a minimum time unit for the scheduling. Furthermore, the number of slots (the number of mini-slots) that makes up the minimum time unit for the scheduling may be controlled.

A TTI that has a time length of 1 ms may be referred to as a usual TTI (a TTI in LTE Re1.8-12), a normal TTI, a long TTI, a usual subframe, a normal subframe, a long subframe, a slot, or the like. A TTI that is shorter than the usual TTI may be referred to as a shortened TTI, a short TTI, a partial TTI (a fractional TTI), a shortened subframe, a short subframe, a mini-slot, a subslot, a slot, or the like.

It is noted that the long TTI (for example, the usual TTI, the subframe, or the like) may be replaced with the TTI that has a time length which exceeds 1 ms, and the short TTI (for example, the shortened TTI or the like) may be replaced with a TTI that has a TTI length which is less than a TTI length of the long TTI and is equal to or longer than 1 ms.

A resource block (RB) is a resource allocation unit in the time domain and the frequency domain, and may include one or more contiguous subcarriers in the frequency domain. The number of subcarriers that are included in the RB may be the same regardless of the numerology, and, for example, may be 12. The number of subcarriers that are included in the RB may be determined based on the numerology.

Furthermore, the time domain of the RB may include one or more symbols and may have a length of one slot, one mini-slot, one subframe, or one TTI. One TTI, one subframe, and the like each may be configured with one or more resource blocks.

It is noted that one or more RBs may be referred to as a Physical Resource Block (PRB), a Sub-carrier Group (SCG), a Resource Element Group (REG), a PRB pair, an RB pair, or the like.

Furthermore, the resource block may be configured with one or more Resource Elements (REs). For example, one RE may be a radio resource region that is one subcarrier and one symbol.

A bandwidth part (BWP) (which may be referred to as a partial bandwidth or the like) may represent a subset of contiguous common resource blocks (RB) for certain numerology in a certain carrier. At this point, the common RB may be specified with an RB index that uses a common reference point of the carrier as a reference. The PRBs may be defined with a certain BWP and may be numbered within the BWP.

A UL BWP and a DL BWP may be included in the BWP. For the UE, one or more BWPs may be configured to be within one carrier.

At least one of the BWPs that are configured may be active, and it may not be assumed that the UE transmits and receives a prescribed signal or channel outside of the BWP that is active. It is noted that, in the present disclosure, “cell”, “carrier”, and the like may be replaced with “BWP”.

Structures of the radio frame, the subframe, the slot, the mini-slot, the symbol, and the like are only described as examples. For example, the number of subframes that are included in the radio frame, the number of slots per subframe or radio frame, the number of mini-slots that are included within the slot, the numbers of symbols and RBs that are included in the slot or the mini-slot, the number of subcarriers that are included in the RB, the number of symbols within the TTI, the symbol length, the Cyclic Prefix (CP) length, and the like can be configured to be variously changed.

In the present disclosure, for example, in a case where articles, such as a, an and the in English, are added during translation, a noun that follows these articles may have the same meaning as when used in the plural.

In the present disclosure, the expression “A and B are different” may mean that “A and B are different from each other”. It is noted that the expression may mean that “A and B are different from C”. The expressions “separated” and “coupled” may also be interpreted in the same manner as the expression “A and B are different”.

(Variation of the Aspect)

The aspects and the embodiments in the present disclosure may be used individually, may be used in combination and may be used in a switching manner depending on implementation. Furthermore, notification (for example, notification that “X is present”) is not limited to being explicitly performed, and may be performed implicitly (for example, notification of prescribed information is not performed).

The detailed description is provided above in the present disclosure, and it is apparent that the present disclosure is not limited to the embodiment that is described in the present disclosure. An amendment and an alteration to the present disclosure can be made without departing from the gist and scope of the present disclosure that is defined by claims. Therefore, the description in the present disclosure is for the purpose of providing an exemplary description and does not impose any limitation in meaning to the present disclosure.

### INDUSTRIAL APPLICABILITY

According to an aspect of the present disclosure, the usefulness to a mobile communication is provided.

### REFERENCE SIGNS LIST

10 Base station
20 Terminal
101, 202 Transmission section
102, 201 Reception section
103, 203 Control section

1. A terminal, comprising:
a reception section that receives adjustment information for adjusting a communication timing that is based on a reference point in time; and
a control section that determines a specific timing for receiving the adjustment information.

2. The terminal according to claim 1, wherein the specific timing is determined by at least one of a prescribed periodicity, reception of configuration information relating to the terminal, and a change in a communication state of the terminal.

3. The terminal according to claim 2, wherein at least one of information relating to the reference point in time, information relating to a frequency band that is allocated to the terminal, and information relating to a transmission and reception point that is configured for the terminal is included in the configuration information.

4. The terminal according to claim 2, further comprising a transmission section that transmits a signal for making a request for transmission of the adjustment information, to a base station, in a case where the change in the communication state satisfies a prescribed condition.

5. A communication method, comprising:
receiving adjustment information for correcting a communication timing that is based on a reference point in time; and
determining a specific timing for receiving the adjustment information.
